(19) United States
(12) Patent Application Publication
(10) Pub. No.: US 2002/0147659 A1
(43) Pub. Date: Oct. 10, 2002

(54) Certified web site business

(76) Inventors: Se June Hong, Yorktown Heights, NY (US); Marshall I. Schor, Katonah, NY (US)

Correspondence Address: McGuireWoods, LLP, 1750 Tysons Boulevard, Suite 1800, Tysons Corner, McLean, VA, 22102-3915, US

(21) Appl. No.: 09/828,796

(22) Filed: Apr. 10, 2001

(51) Int. Cl. G06F 17/60

(52) U.S. Cl. 705/26; 707/3

(57) ABSTRACT

A Web site serves as a portal to only certified Web sites where any products or services listed through these Web sites are certified as genuine. The Web site (named, for example, certified.com) assures the claims by verifying and obtaining strict guarantees from the client companies whose Web sites are listed in the certified.com Web site. The certification can be restricted to apply only to a portion of a client Web site. The invention solves the problem of lack of knowledge about the trustworthiness of Web sites by providing “checking” services that verify the claims made for a Web business. The checking is done via normal audit procedures, as is currently customary, and the keeping of records. The Web site is an Internet version of such assurances as UL listings and Good Housekeeping Seals of Approval so that customers can trust what they get from Web sites; however, the Web site goes beyond just putting a seal on a product or service. It clearly marks what claim about each item offered is certified. The client companies that list their business products pay certified.com fees for its certification of their Web site, and guarantee continued compliance with the certification by a contract with appropriate clauses in case of violations. Certified.com also generates revenue for advertisements on its Web page and hits made through its Web page search engine.

### BACKGROUND OF THE INVENTION

1. Field of the Invention

The present invention generally relates to electronic business (e-business) and, more particularly, to a Web site through which customers may search for products and services that are certified regarding certain aspects of their business products and services.

2. Background Description

When a person navigates through typical Web sites, there is little guarantee that the claims for the products or services that are advertised or offered are genuine as claimed. In “bricks-and-mortar” businesses, as contrasted with businesses on the Internet, certifications are provided by such institutions as Underwriter Laboratories (UL), Good Housekeeping, etc. These certifications assure consumers of the quality and claims of products to a certain degree.

### SUMMARY OF THE INVENTION

It is therefore an object of the present invention to provide a Web site which is a portal to only those Web sites that contain certified products or services customers desire to find.

According to the invention, a Web site (named, for example, “certified.com”) is established and maintained by a certification service. This certification service may be a stand alone business or a service sponsored by an existing business. If an existing business, the name of that business may be incorporated into the Web site (say, “certified.ibm.com”) in order to induce or enhance customer trust in the certification service. The certification service assures the claims of a product or service provider by verifying and obtaining strict guarantees from the client providers (e.g., companies, individuals, etc.) whose Web sites and products or services are listed in the Web site. The certification can be restricted to apply only to a portion of a client provider Web site, product or service. In this way, the invention solves the problem of lack of knowledge about the trustworthiness of Web sites by providing “checking” services that verify the claims made by a Web business for its products or services. The checking is done via normal audit procedures, as is currently customary, and the keeping of records.

The invention is an Internet version of such assurances as UL listings and Good Housekeeping Seals of Approval so that customers can trust what they get from Web sites; however, the invention goes beyond just putting a seal on a product or service. It clearly marks what claim about each item offered is certified. The client companies that list their business products pay certified.com fees for its certification of their Web site, and guarantee continued compliance with the certification by a contract with appropriate clauses in case of violations. Certified.com also generates revenue from advertisements on its Web page and hits made through its Web page search engine.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the certified.com Web page and its connection via a server with a domain database; and

FIG. 2 is a flow diagram showing the business process flow according to the invention.

### DETAILED DESCRIPTION OF A PREFERRED EMBODIMENT OF THE INVENTION

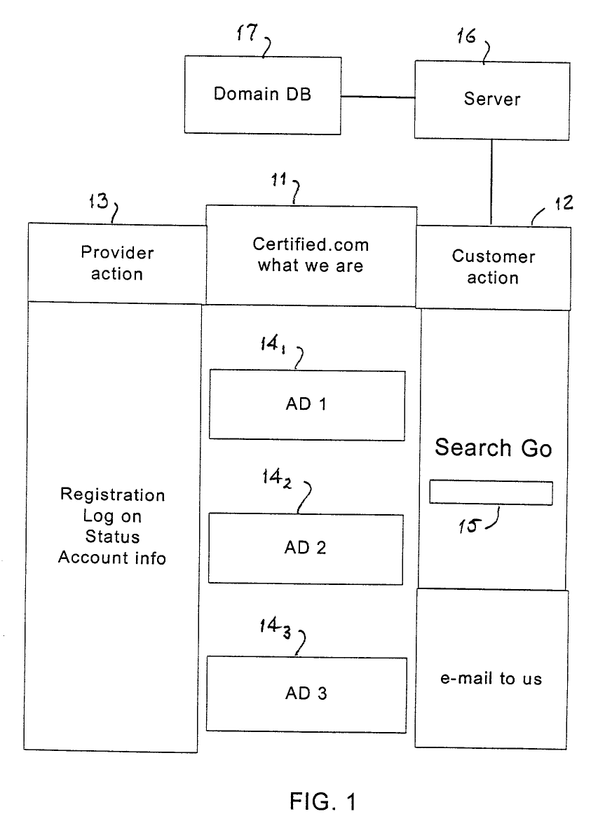

Referring now to the drawings, and more particularly to FIG. 1, there is shown a block diagram illustrating the certified.com Web page and its connection via a server with a domain database. The Web page is roughly divided into three parts: a central part 11 in which various advertisements are posted, a customer part 12 in which customers may search the Web site, or send e-mail to certified.com, and a provider part 13 in which client providers can register, log on, inquire about status, and obtain account information.

In the central part 11, there is a word phrase “what we are” below the logo for certified.com which can be clicked on to link the user of the Web site to information about the company, what is being certified and recourse to a provider if a product or service fails to be as certified. There are several advertisements 14₁, 14₂ and 14₃ in this section, and each of these can be clicked on to activate hypertext links to pages that reveal more about the subject product or service, the features certified and information about the provider of the product or service.

In the customer part 12, a search window 15 is provided in which a customer can enter a key word or phrase to be searched by a search engine. Once the key word or phrase has been entered into the window 15, the customer clicks on the word “Go” which causes the key word or phrase to be passed to a search engine implemented on a server 16. The customer can also send e-mail to certified.com by clicking on the phrase “e-mail to us”. Clicking on this will link to a page containing a form which can be filled in by the customer and then submitted to certified.com.

The provider part 13 has four words or phrases, each of which can be clicked on by a provider to link to pages containing a form that the provider fills in and submits to certified.com to either register, log on to the site or obtain information.

The server 16 is connected to a data base 17 which feeds the business process applications that reside in the certified.com's server. The search engine is for customers' (consumer clients) use. Activity monitoring and analysis provides information for the push engine. The push engine volunteers the offerings according to the estimated customer preferences. An invoice generator for the provider clients bills for certified services rendered. A dynamic Web page composition engine modifies the Web page based on information generated by the search engine and the push engine.

The purpose of the Web site is to certify products and services. This certification is not a general seal of approval or recommendation; rather, it is a certification of the truth of certain claims made about a product or service. Among the things that can be certified are

1) the specifications of a product,

2) claims of authenticity made by the provider,

3) titles to a product or products,

4) service guarantees (performance, delivery time, repair time, etc.) made by the provider,

5) provider qualifications (certifications, licensed, insured, etc.)

6) price guarantees,

7) warrantees, and

8) merchandise return policy.

Not all facts claimed are necessarily certified. Those which are certified are individually and explicitly specified. More particularly, what is certified is prominently highlighted in the Web page either by flashing entry or some easily spotted color or boundary. Highlighted entries in the Web page include hypertext links to information concerning the entries. Clicking on the entry will give the details of the certification including effective date and remedy in the case of violation. The agreement between certified.com and a client provider allows certified.com to directly rule on customer/provider disputes according to the terms and conditions established with the client provider.

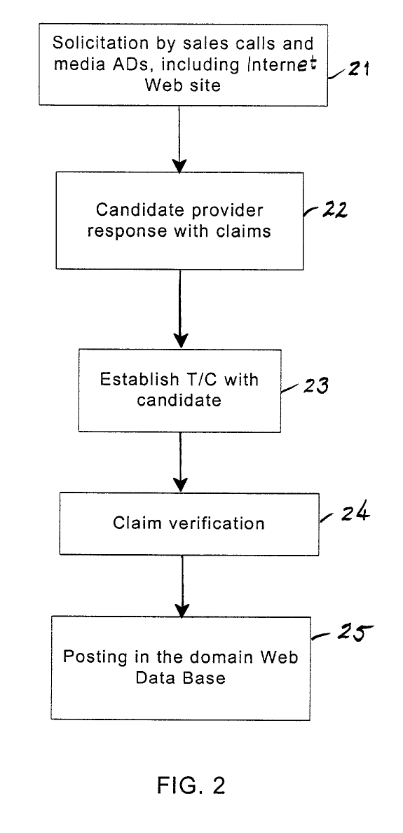

FIG. 2 shows the flow of the business process. The business method begins by solicitation of candidate providers in step 21. This solicitation may be by direct sales calls, media advertisements, telephone solicitations, or, as indicated by FIG. 1, the Web page of certified.com. A candidate provider responds in step 22 with a list of claims for its product or service which it desires to be certified. In step 23, a contract is established with the candidate provider which establishes the rights and liabilities between certified.com and the candidate provider. These include the fees payable to certified.com for verification of the candidate provider's claims for its product or service and posting of the verified claims on certified.com's Web page. It also establishes the remedies that certified.com can provide customers against the candidate provider for certification violations. Once the contract has been established, certified.com performs the claim verification in step 24. Those claims that are verified are posted in the domain Web data base 17 in step 25. Advertisements posted on the Web page will prominently indicate the certified claims for the provider's product or service.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of providing certifications of claims made for products or services on which customers may rely comprising the steps of:
establishing a certification service which maintains a Web page;
entering into a contract between the certification service and a provider of a product or service for which the provider makes certain claims;
verifying the claims made by the provider for the product or service under terms of the contract; and
posting information on the Web page about the product or service in which the those claims verified as true are prominently displayed.

2. The method of providing certifications recited in claim 1, wherein the Web page is accessible over the Internet by customers.

3. The method of providing certifications recited in claim 2, further comprising the steps of:
maintaining a database of verified claims for products and services provided by a plurality of providers; and
providing customers with search engine for searching the database for certified products and services in the database.

4. The method of providing certifications recited in claim 3, wherein the search engine responds to key words and phrases entered by customers by searching the data base for certifications of product or service claims.

5. The method of providing certifications recited in claim 1, wherein the contract with the provider establishes rights and liabilities between the certification service and the provider, including guarantees by the provider of continued compliance with the certification with remedies in case of violations by the provider.

6. The method of providing certifications recited in claim 5, wherein the Web page includes links from a displayed certified product or service to details of the certification for that product or service, including effective date and remedy in case of violation.

7. The method of providing certifications recited in claim 6, wherein the certification service directly rules on customer/provider disputes according to the terms and conditions established with the client provider under the contract.

8. The method of providing certifications recited in claim 7, wherein the Web page is accessible over the Internet by customers.

9. The method of providing certifications recited in claim 8, further comprising the steps of:
maintaining a database of verified claims for products and services provided by a plurality of providers; and
providing customers with search engine for searching the database for certified products and services in the database.

10. The method of providing certifications recited in claim 9, wherein the search engine responds to key words and phrases entered by customers by searching the data base for certifications of product or service claims.

11. The method of providing certifications recited in claim 1, wherein the certification service is a stand alone business.

12. The method of providing certifications recited in claim 2, wherein the certification service is established by an existing business and the Web page identifies the existing business as the sponsor of the certification service.
